(19) United States
(12) Patent Application Publication
(10) Pub. No.: US 2011/0301991 A1
(43) Pub. Date: Dec. 8, 2011

(54) METHODS AND SYSTEMS FOR SCHEDULING APPOINTMENTS IN HEALTHCARE ENVIRONMENTS

(75) Inventor: Sten Herlitz, Boston, MA (US)

(73) Assignee: General Electric Company, Schenectady, NY (US)

(21) Appl. No.: 12/793,401

(22) Filed: Jun. 3, 2010

(51) Int. Cl. G06Q 10/00; G06Q 50/00; G06Q 99/00

(52) U.S. Cl. 705/7.13

(57) ABSTRACT

Methods and systems for scheduling appointments in healthcare environments are described. An example medical scheduling system includes a data storage to store data including information associated with an open appointment and information associated with at least one of a type of care or a symptom exhibited by a patient and a processor to receive input from a first access device associated with the open appointment. The processor to identify a patient appointment request based on at least one of a type of care or a symptom exhibited by the patient from input received from a second access device. The processor to convey input received from the first access device to the second access device to facilitate scheduling the patient in the open appointment.

### BACKGROUND

Healthcare environments, such as hospitals and clinics, typically include information systems to assist in scheduling appointments for patients. In some instances, patients having scheduled appointments may cancel at the last minute. If unfilled, these cancelled appointments may go unutilized.

### SUMMARY

An example computer implemented method of facilitating the scheduling of appointments in healthcare environments includes identifying an available opening associated with a provider. The provider is to communicate with a scheduling system regarding the available opening. The method includes identifying one or more stand-by patients seeking an appointment. The one or more stand-by patients are to communicate with the scheduling system regarding an appointment sought including criteria based on at least one of a type of care or a symptom exhibited. The method includes determining whether the criteria of the one or more stand-by patients is met by the available opening using a processor and notifying the provider of one of the one or more stand-by patients having their criteria met by the available opening. The method includes facilitating scheduling of the one of the one or more stand-by patients in the available opening and notifying the one of the one or more stand-by patients of a scheduling confirmation associated with the available opening.

An example computer implemented method of facilitating the scheduling of appointments in healthcare environments includes enabling a stand-by patient to communicate with a scheduling system regarding an appointment sought including criteria based on at least one of a type of care or a symptom exhibited. The example method includes identifying one or more providers based on the criteria and determining if the one or more providers has an available opening that meets the criteria of the stand-by patient. The one or more providers are to communicate with the scheduling system regarding the available opening that meets the criteria of the stand-by patient. The example method includes notifying the stand-by patient of one or more available openings that meet the criteria of the stand-by patient and facilitating scheduling of the stand-by patient in one of the one or more available openings.

An example medical scheduling system includes a data storage to store data including information associated with an open appointment and information associated with at least one of a type of care or a symptom exhibited by a patient and a processor to receive input from a first access device associated with the open appointment. The processor to identify a patient appointment request based on at least one of a type of care or a symptom exhibited by the patient from input received from a second access device. The processor to convey input received from the first access device to the second access device to facilitate scheduling the patient in the open appointment.

### BRIEF DESCRIPTION OF THE DRAWINGS

FIG. 1 is a block diagram of an example medical scheduling or appointment system.

FIG. 2 is a block diagram of an example apparatus that may be used to implement the examples described herein.

FIGS. 3-5 are flow diagrams of example methods that can be used to implement the examples described herein.

FIG. 6 is a schematic illustration of an example processor platform that may be used and/or programmed to implement any or all of the example methods and systems described herein.

The foregoing summary, as well as the following detailed description of certain examples, will be better understood when read in conjunction with the appended drawings. For the purpose of illustrating the examples described herein, certain examples are shown in the drawings. It should be understood, however, that the present disclosure is not limited to the arrangements and instrumentality shown in the attached drawings.

### DETAILED DESCRIPTION

Although the following discloses example methods, apparatus, systems, and articles of manufacture including, among other components, firmware and/or software executed on hardware, it should be noted that such methods, apparatus, systems, and/or articles of manufacture are merely illustrative and should not be considered as limiting. For example, it is contemplated that any or all of these firmware, hardware, and/or software components could be embodied exclusively in hardware, exclusively in software, exclusively in firmware, or in any combination of hardware, software, and/or firmware. Accordingly, while the following describes example methods, apparatus, systems, and/or articles of manufacture, the examples provided are not the only way(s) to implement such methods, apparatus, systems, and/or articles of manufacture.

When any of the appended claims are read to cover a purely software and/or firmware implementation, at least one of the elements in at least one example is hereby expressly defined to include a tangible medium such as a memory, DVD, CD, Blu-ray, etc. storing the software and/or firmware.

The examples described herein relate to systems that enable medical providers to post openings in their schedule and enable patients or referring providers to book appointments for those openings that may otherwise go unutilized. If the appointments go unutilized, it represents a missed opportunity for both the provider and other patients. The system may be associated with a web server and/or website and the openings may be due to last-minute cancellations or unfilled appointments. The examples described herein relate to systems that enable patients to register themselves as a standby for the next opening that meets some specific criteria.

Because of short time periods between the time at which a healthcare provider is notified of a cancellation and the time of the appointment itself, finding another patient to fill the now open appointment may be difficult. The examples described herein facilitate filling appointments left open by last minute cancellations or otherwise left unfilled. In some examples, plugins/extensions implemented in a healthcare facility scheduling system and/or a scheduling system external to the healthcare facility (e.g., a web server hosting a scheduling service associated with the plugins/extensions) may be utilized to facilitate automatically identifying open appointments at healthcare facilities (e.g., the healthcare facility scheduling system or a healthcare facility being accessed). In some examples, plugins/extensions implemented in a healthcare facility scheduling system and/or a scheduling system external to the healthcare facility (e.g., a web server hosting a scheduling service associated with the plugins/extensions) may be utilized to automatically post open appointments once identified (e.g., the open appointments being accessible by accessing the web server). In some examples, plugins/extensions implemented in a healthcare facility scheduling system, a scheduling system external to the healthcare facility (e.g., a web server hosting a scheduling service associated with the plugins/extensions) and/or a patient access device (e.g., a mobile device, a desktop, etc. accessing the web server) may be utilized to facilitate automatically scheduling patients in open appointments. In some examples, providers may compensate referring providers that are able to fill open appointments.

Patients in need of medical services may be unaware of providers that provide such medical services and/or are unaware of providers that have an open appointment(s) that meet the user's availability, preferences, etc. The examples described herein facilitate identifying available opening for such patients. In some examples, plugins/extensions implemented in a healthcare facility scheduling system and/or a scheduling system external to the healthcare facility (e.g., a web server hosting a scheduling service associated with the plugins/extensions) may be utilized to facilitate automatically identifying open appointments at healthcare facilities meeting the patient's request. In some examples, once accepted by the patient, plugins/extensions implemented in a healthcare facility scheduling system, a scheduling system external to the healthcare facility (e.g., a web server hosting a scheduling service associated with the plugins/extensions) and/or a patient access device (e.g., a mobile device, a desktop etc., accessing the web server) may be utilized to facilitate automatically scheduling patients in open appointments.

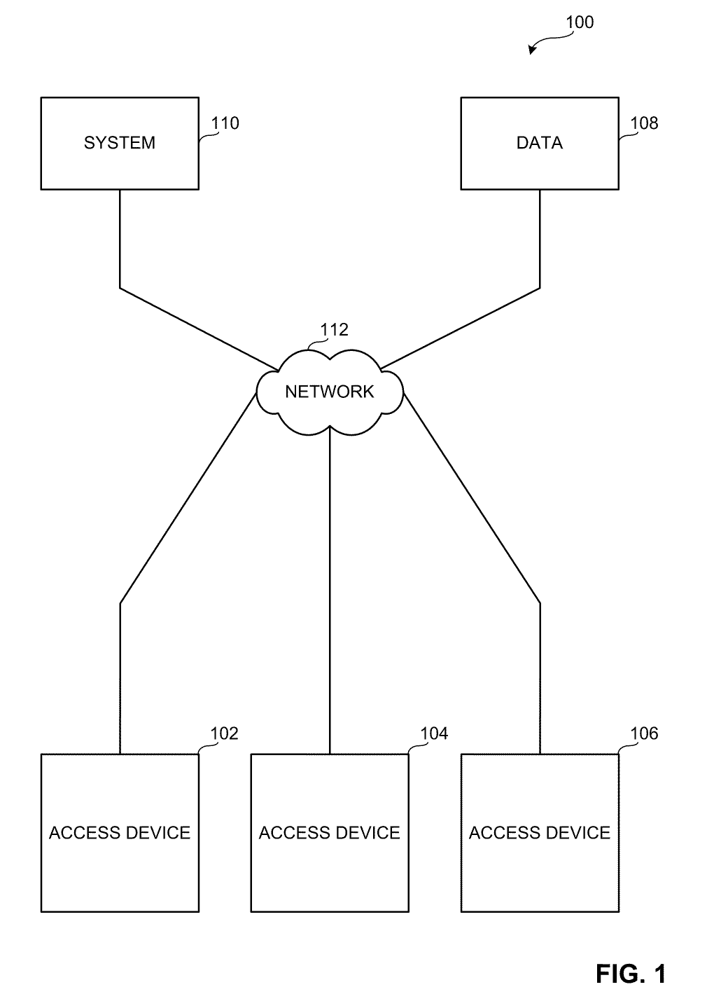

FIG. 1 depicts an example medical scheduling or appointment system 100 that includes a first access device 102, a second access device 104, a third access device, a data store or source 108 and a system 110. In some examples, the data source 108 and/or the system 110 can be implemented in a single system. In some examples, the data source 108 and/or the system 110 can communicate with one or more of the access devices 102-106 via a network 112. In some examples, the one or more access devices 102-106 can communicate with the data source 108 and/or the system 110 via the network 112. In some examples, the access devices 102-106 can communicate via the network 112. The network 112 may be implemented by, for example, the Internet, an intranet, a private network, a wired or wireless Local Area Network, a wired or wireless Wide Area Network, a cellular network, and/or any other suitable network.

The data source 108 can provide scheduling information and/or other data to the access devices 102-106 to facilitate filling open time slots or appointments and/or fulfilling patient requests. In some examples, the data source 108 can receive information associated with an open time slot or appointment and/or other information from one of the access devices 102-106. In some examples, the system 110 can receive information associated with an open time slot or appointments and/or other information from one of the access devices 102-106. In some examples, the data source 108 can receive information associated with a patient request from one of the access devices 102-106. In some examples, the system 110 can receive information associated with a patient request from one of the access devices 102-106. The data source 108 and/or the system 110 can be implemented using a system such as a PACS, RIS, HIS, CVIS, EMR, archive, data warehouse.

The access devices 102-106 can be implemented using a workstation (a laptop, a desktop, a tablet computer, etc.) or a mobile device, for example. Some mobile devices include smart phones (e.g., BlackBerry™, iPhone™, etc.), Mobile Internet Devices (MID), personal digital assistants, cellular phones, handheld computers, tablet computers (iPad™), etc., for example. In some examples, the access devices 102-106 may be located at or associated with a healthcare provider or organization.

In some examples, healthcare providers may have appointments that are open due to last minute cancellations, for example. These open appointments, unless filled, go unutilized. In some examples, because of a short time period between the time at which the healthcare provider is notified of a cancellation and the time of the appointment itself, finding another patient to fill the now open appointment may be difficult.

In such instances, using the examples described herein, the access devices 102-106, the data source 108 and/or the system 110 may interact to facilitate filling the open appointment. For example, a first user associated with the first access device 102 may communicate with the data source 108 and/or the system 110 to notify the data source 108 and/or the system 110 of an open appointment. The first user may be associated with a healthcare facility, organization and/or scheduling system, for example. The data source 108 and/or the system 110 may open and save an entry associated with the open appointment on the data source 108 and/or the system 110. The data source 108 and/or the system 110 may perform processes to fill the open appointment. In some examples, the processes include enabling users to request an appointment having certain criteria (time, location, distance, procedure performed, health insurance plan, type of care, symptom exhibited, other preferences, etc.). In some examples, the processes include identifying stand-by patients having their criteria met by the open appointment. In some examples, the processes include communicating with stand-by users or other users. In some examples, the processes include communicating with the facility requesting that the open appointment be filled. In some examples, the processes include posting the availability of the open appointment on a public forum or website. In some examples, the processes include interacting with healthcare provider scheduling systems to automatically identify open appointments. In some examples, the processes include interacting with healthcare provider scheduling systems to automatically schedule users in open appointments.

In practice, users may be given priority to open appointments based on certain criteria. Users having higher priority may have the option to and/or be scheduled for the open appointment prior to users having lower priority. In some examples, stand-by users having elected to auto-accept open appointment(s) may be given priority over stand-by users having elected to be notified of open appointment(s) but not to auto-accept. In some examples, stand-by users having elected to be notified of the open appointment(s) may be given priority over users accessing a public forum or website associated with the data source 108 and/or the system 110. Open appointments may be posted on the forum or website if no stand-by users accept the appointment within a predetermined time period, for example.

The data source 108 and/or the system 110 may convey information associated with the open appointment to a second user at the second access device 104 and/or a third user at the third access device 106. The second user and/or the third user may be stand-by patients or referring providers whose criteria has been met by the open appointment and/or who has requested to be notified of open appointments, for example.

In some examples, if the second user is a stand-by patient having elected to auto-accept appointments meeting certain criteria and the third user is a stand-by patient having elected to be notified of open appointments but not to auto-accept, the second user may have higher priority than the third user and, thus, the third user may not be notified of the open appointment in such instances. The data source 108 and/or the system 110 may then convey to the first access device 102 that the second user would like to be scheduled in the open appointment. Additionally, the data source 108 and/or the system 110 may close the entry relating to the previously open appointment. In some examples, the data source 108 and/or the system 110 may interact with the first access device 102 and/or a scheduling system associated with the first access device 102 to facilitate scheduling the second user in the open appointment. In some examples, the data source 108 and/or the system 110 may facilitate scheduling the second user in the open appointment by providing the first user at the first access device 102 with contact information of the second user at the second access device 104. Once scheduled, the first access device 102, the data source 108 and/or the system 110 may inform the second user, via the second access device 104, that they are scheduled in the appointment via scheduling confirmation, for example.

In some examples, if the second and third users are stand-by patients that elected to be notified of open appointments, the data source 108 and/or the system 110 may notify both the second user at the second access device 104 and the third user at the third access device 106 of the available opening. The users may be notified by voice or text messaging (e.g., phone, SMS, e-mail services, etc.).

Depending on which of the second user or the third user responds to the data source 108 and/or the system 110 first, the data source 108 and/or the system 110 may convey to the first access device 102 that the user having first responded would like to be scheduled in the open appointment. The users may respond by voice or text messaging (e.g., phone, SMS, e-mail services, etc.). Additionally, the data source 108 and/or the system 110 may close the entry relating to the previously open appointment. Once scheduled, the first access device 102, the data source 108 and/or the system 110 may inform the user, via the access device 104 or 106, that they are scheduled in the appointment via a scheduling confirmation, for example.

In some examples, if the second and third users are stand-by patients that elected to be notified of open appointments, the data source 108 and/or the system 110 may notify both the second user at the second access device 104 and the third user at the third access device 106 of the available opening. If neither of the second user at the second access device 104 or the third user at the third access device 106 responds to the notice within a predetermined time period, the data source 108 and/or the system 110 may post the open appointment on a publicly available forum or website, for example. Users that are not registered as stand-by users (e.g., non-stand-by users) may view the forum or website to become notified of the open appointment.

In other examples, the data source 108 and/or the system 110 may post the open appointment using blogging, microblogging or social networking service(s). In such examples, users that have registered for the service may be notified of the open appointment. Depending on which of the non-stand-by users responds to the data source 108 and/or the system 110 first, the data source 108 and/or the system 110 may convey to the first access device 102 that the user having first responded would like to be scheduled in the open appointment. Additionally, the data source 108 and/or the system 110 may close the entry relating to the previously open appointment. Once scheduled, the first access device 102, the data source 108 and/or the system 110 may inform the user, via an access device associated with the user, that they are scheduled in the appointment via a scheduling confirmation, for example.

In some examples, patients in need of medical services may be unaware of providers that provide such medical services and/or are unaware of providers that have an open appointment(s) that meet the user's availability, preferences, etc. To identify such a provider and/or an open appointment, patients may spend large amounts of time contacting numerous different providers, for example.

In such instances, using the examples described herein, the access devices 102-106, the data source 108 and/or the system 110 may interact to facilitate identifying an open appointment meeting the user's request. For example, a first user associated with the first access device 102 may communicate with the data source 108 and/or the system 110 to notify the data source 108 and/or the system 110 of a request for an appointment (e.g., medical service request) along with any other preferences (e.g., availability, location, distance, procedure performed, health insurance plan, type of care, symptom exhibited, etc.). The first user may be associated with a patient in need of medical services. The data source 108 and/or the system 110 may open and save an entry associated with the appointment request at the data source 108 and/or the system 110.

The data source 108 and/or the system 110 may perform processes to identify an open appointment(s) that meet the user's request. In some examples, the processes include identifying healthcare providers that have available openings that meet the user's request. In some examples, the processes include communicating with the user. In some examples, the processes include communicating with healthcare providers. In some examples, the processes include interacting with healthcare provider scheduling systems to automatically identify open appointments that meet the user's request. In some examples, the processes include interacting with healthcare provider scheduling systems to automatically schedule users in open appointments.

In practice, once the first user has submitted the appointment request to the data source 108 and/or the system 110, the data source 108 and/or the system 110 may identify healthcare providers that provide such services. For example, if the first user submits a request to see a podiatrist, the data source 108 and/or the system 110 may identify podiatrists from a list of healthcare providers, for example. In identifying the podiatrist, the data source 108 and/or the system 110 may filter the results based on criteria entered by the first user such as, the distance that the first user is willing to travel for the appointment, for example.

The data source 108 and/or the system 110 may then convey to the first user at the first access device 102 the list of identified healthcare providers. The first user may then review the list of identified providers and, in some examples, remove or reprioritize the list. The list (e.g., the amended list) may then be conveyed to the data source 108 and/or the system 110.

The information associated with the request may be conveyed to a second user at the second access device 104 and/or a third user at the third access device 106. The users may be notified by voice or text messaging (e.g., phone, SMS, e-mail services, etc.). The second user and/or the third user may be a healthcare facility, organization and/or scheduling system included in the identified list of providers (e.g., the amended list), for example. In such examples, if the second user or the third user has an available appointment that meets that first user's request, the respective user may convey to the data source 108 and/or the system 110 that they have an available opening. The users may respond by voice or text messaging (e.g., phone, SMS, e-mail services, etc.).

If the second user at the second access device 104 responds to the data source 108 and/or the system 110 indicating that they do not have an open appointment meeting the first user's request, the data source 108 and/or the system 110 may keep the request entry open and, in some examples, convey a request to another one of the identified providers on the list. If the third user at the third access device 106 responds to the data source 108 and/or the system 110 indicating that they have an open appointment that meets the first user's request, the data source 108 and/or the system 110 may convey to the first user at the first access device 102 that the third user has an available opening. The first user at the first access device 102 may then respond to the third access device 106, the data source 108 and/or the system 110 indicating that they accept or decline the appointment. The first user may respond by voice or text messaging (e.g., phone, SMS, e-mail services, etc.).

If the first user accepts the open appointment at the third access device 106, the data source 108 and/or the system 110 may convey to the third access device 106 that the first user has accepted the appointment. In some examples, once accepted, the data source 108 and/or the system 110 may facilitate scheduling the first user in the open appointment by automatically scheduling the first user in the appointment by interacting with the third access device 106 or a scheduling system associated with the third access device 106. In some examples, once accepted, the data source 108 and/or the system 110 may facilitate scheduling the first user in the open appointment by providing contact information of the third user at the third access device 106 to the first user at the first access device 102. Additionally, the data source 108 and/or the system 110 may close the entry relating to the previously open request. Once scheduled, the third access device 106, the data source 108 and/or the system 110 may inform the user, via the first access device 102, that they are scheduled in the appointment via a scheduling confirmation, for example.

While the above described examples relate to requesting and/or filling appointments in the medical industry, the examples described herein may be used in any other industry. For example, appointments may be requested and/or filled in industries such as automotive services, repair or installation services, salon services, zoning board appointments, hospitality services, etc.

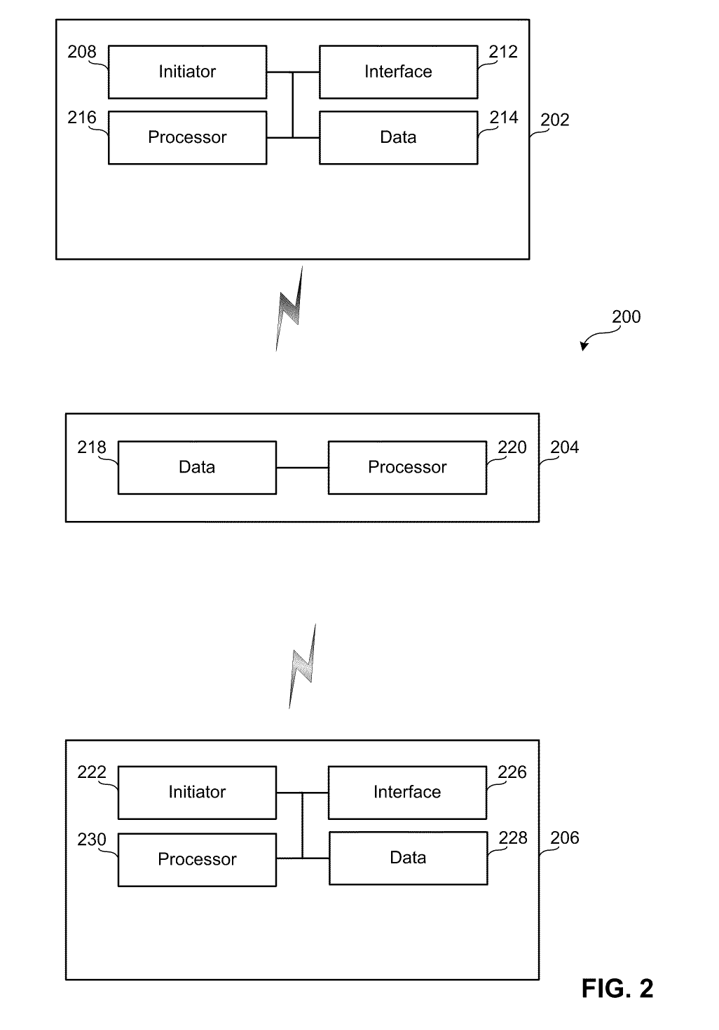

FIG. 2 is a block diagram of an example first access device 202, an example scheduling system 204 and an example second access device 206 of a medical scheduling or appointment system 200. The first access device 202 may be used to implement the first access device 102 of the FIG. 1. The scheduling system 204 may be used to implement the data source 108 and/or the system 110 of FIG. 1. The second access device 206 may be used to implement the second access device 104 of FIG. 1.

The first access device 201 may include an initiator 208, an interface 212, a data source 214 and a processor 216. The scheduling system 204 may include a data storage or source 218 and a processor 220. The second access device 206 may include an initiator 222, an interface 226, a data source 228 and a processor 230. While an example manner of implementing the access devices 102 and 104 and the data source 108 and/or the system 110 of FIG. 1 have been illustrated in FIG. 2, one or more of the elements, processes and/or devices illustrated in FIG. 2 may be combined, divided, re-arranged, omitted, eliminated and/or implemented in other ways. In some examples, the processor 216 may be integrated into the initiator 208, the interface 212 and/or the data source 214. Additionally or alternatively, in some examples, the processor 230 may be integrated into the initiator 222, the interface 226, the data source 228 and/or the processor 230. Additionally or alternatively, in some examples the processor 220 may be integrated into the data source 218. The initiators 208 and/or 222, the interfaces 212 and/or 226, the data sources 214, 218 and/or 228, and/or the processors 216, 220 and/or 230 and, more generally, the example medical scheduling or appointment system 200 may be implemented by hardware, software, firmware and/or a combination of hardware, software and/or firmware. Thus, the initiators 208 and/or 222, the interfaces 212 and/or 226, the data sources 214, 218 and/or 228, and/or the processors 216, 220 and/or 230 and, more generally, the example medical scheduling or appointment system 200 can be implemented by one or more circuit(s), programmable processor(s), application specific integrated circuit(s) (ASIC(s)), programmable logic device(s) (PLD(s)) and/or field programmable logic device(s) (FPLD(s)), etc. When any of the appended claims are read to cover a purely software and/or firmware implementation, at least one of the initiators 208 and/or 222, the interfaces 212 and/or 226, the data sources 214, 218 and/or 228, and/or the processors 216, 220 and/or 230 and, more generally, the example medical scheduling or appointment system 200 are hereby expressly defined to include a tangible medium such as a memory, DVD, CD, Blu-ray, etc., storing the software and/or firmware. Further still, the example medical scheduling or appointment system 200 of FIG. 2 may include one or more elements, processes and/or devices in addition to, or instead of, those illustrated in FIG. 2, and/or may include more than one of any or all of the illustrated elements, processes and devices.

The access devices 202 and 206 and the scheduling system 204 include the processors 216, 220 and 230 retrieving data, executing functionality and storing data at the respective access devices 202 or 206, the scheduling system 204, the data source 108 (FIG. 1) and/or the system 110 (FIG. 1). The processors 216 and 230 drive respective interfaces 212 and 226 providing information and functionality to a user input to control the access devices 202 and 206, edit information, etc. In some examples, the interfaces 212 and/or 224 may be configured as a graphical user interface (GUI). The GUI may be a touch pad/screen integrated with and/or attached to the respective access devices 202 or 206. In some examples, the interfaces 212 and/or 224 may be a keyboard, mouse, track ball, microphone, etc.

The access devices 202 and 206 and the scheduling system 204 include one or more internal memories and/or data stores including the data sources 214, 218 and 228. Data storage can include any variety of internal and/or external memory, disk, remote storage communicating with the access devices 202 and 206 and/or the scheduling system 204.

The processor 216, 220 and/or 230 can include and/or communicate with a communication interface component to query, retrieve, and/or transmit data to and/or from the first access device 202 and the second access device 206, the scheduling system 204 and/or the data source 108 (FIG. 1) and/or the system 110 (FIG. 1), for example. Using user input received via the interface 226 as well as information and/or functionality from the data source 228, the processor 230 can convey a notice associated with an open appointment to the scheduling system 204 which in turn is conveyed to the first access device 202, for example. Using user input received via the interface 212 as well as information and/or functionality from the data source 214, the processor 216 can convey an appointment request to the scheduling system 204 which in turn is conveyed to the second access device 206, for example.

In some examples, in operation, a healthcare facility associated with the first access device 202 may notify the scheduling system 204 of an open appointment using the initiator 208. In some examples, the open appointment may be a last minute cancellation. The request may be conveyed, via the processor 216, to the scheduling system 204 where the processor 220 may open an entry associated with the open appointment.

If a user associated with the second access device 206 is a stand-by patient that has elected to auto-accept appointments, the information associated with the stand-by appointment request may be stored in the data source 218. The processor 220 may identify the stand-by patient associated with the user and notify the healthcare facility of the user's availability to schedule in the open appointment. The healthcare facility at the first access device 202 may then schedule the user associated with the second access device 206 in the available opening. In some examples, the processor 216 may schedule the user in the open appointment and notify the user at the second access device 206 to confirm. In some examples, the processor 216 may schedule the user in the open appointment and notify the scheduling system 204 to confirm which is in turn conveyed, via the processor 220, to the user at the second access device 206, for example. The processor 220 may close the entry relating to the previously open appointment.

If a user associated with the second access device 206 is a stand-by patient that has elected to receive notifications relating to open appointments, the information associated with the stand-by appointment request may be stored in the data source 218. The processor 220 may identify the stand-by patient associated with the user and notify the user at the second access device 206 of the open appointment. The user may then accept or decline the request using the interface 226. The acceptance or denial may be conveyed from the second access device 206 to the scheduling system 204 using the processor 230, for example.

If the user accepts the request, the processor 220 notifies the healthcare facility of the user's availability to schedule in the open appointment. The healthcare facility at the first access device 202 may then schedule the user associated with the second access device 206 in the available opening. In some examples, the processor 216 may schedule the user in the open appointment and notify the user at the second access device 206 to confirm. In some examples, the processor 216 may schedule the user in the open appointment and notify the scheduling system 204 to confirm which is in turn conveyed, via the processor 220, to the user at the second access device 206, for example. The processor 220 may close the entry relating to the previously open appointment.

If a user associated with the second access device 206 is a non-stand-by patient, the user may become notified of the open appointment by visiting a forum, website, etc. where the open appointment has been posted. The user may accept the open appointment using the interface 226.

If the user accepts the request, the processor 220 notifies the healthcare facility of the user's availability to schedule in the open appointment. The healthcare facility at the first access device 202 may then schedule the user at the second access device 206 in the available opening. In some examples, the processor 216 may schedule the user in the open appointment and notify the user at the second access device 206 to confirm. In some examples, the processor 216 may schedule the user in the open appointment and notify the scheduling system 204 to confirm which is in turn conveyed, via the processor 220, to the user at the second access device 206, for example. The processor 220 may close the entry relating to the previously open appointment.

In some examples, in practice, a user associated with the second access device 206 may notify the scheduling system 204 of a request for an appointment using the initiator 222. In some examples, the user may enter criteria associated with the request using the interface 226. The request may be conveyed, via the processor 230, to the scheduling system 204 where the processor 220 may open an entry associated with the appointment request.

The information associated with the appointment request may be conveyed to a healthcare facility associated with the first access device 102. The healthcare facility may accept or decline the request using the interface 212. If the healthcare facility accepts the request, the processor 220 notifies the user of the available opening. The user may then accept or decline the appointment using the interface 226. If the user accepts the request, the processor 220 notifies the healthcare facility of the user's acceptance. The healthcare facility at the first access device 202 may then schedule the user at the second access device 206 in the available opening. In some examples, the processor 216 may schedule the user in the open appointment and notify the user at the second access device 206 to confirm. In some examples, the processor 216 may schedule the user in the open appointment and notify the scheduling system 204 to confirm which is in turn conveyed, via the processor 220, to the user at the second access device 206, for example. The processor 220 may close the entry relating to the previously open appointment.

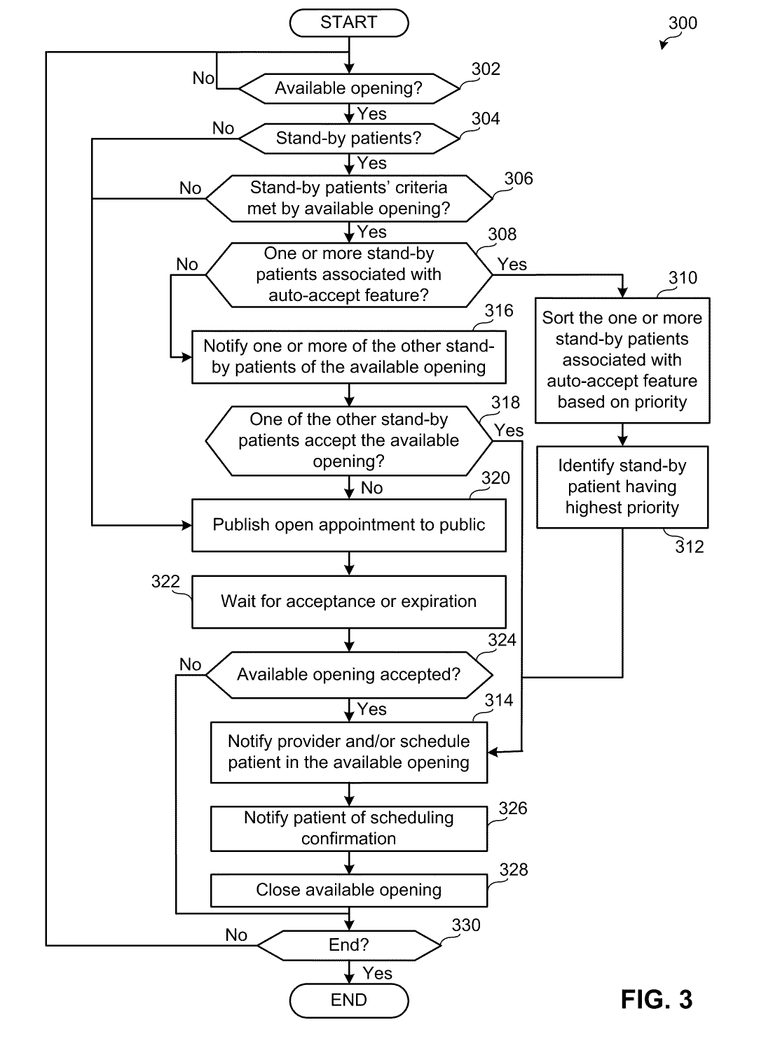

FIGS. 3-5 depict example flow diagrams representative of processes that may be implemented using, for example, computer readable instructions that may be used to facilitate requesting and/or filling medical appointments using a plurality of access devices, a scheduling system, a data store and/or a system. The example processes of FIGS. 3-5 may be performed using a processor, a controller and/or any other suitable processing device. For example, the example processes of FIGS. 3-5 may be implemented using coded instructions (e.g., computer readable instructions) stored on a tangible computer readable medium such as a flash memory, a read-only memory (ROM), and/or a random-access memory (RAM). As used herein, the term tangible computer readable medium is expressly defined to include any type of computer readable storage and to exclude propagating signals. Additionally or alternatively, the example processes of FIGS. 3-5 may be implemented using coded instructions (e.g., computer readable instructions) stored on a non-transitory computer readable medium such as a flash memory, a read-only memory (ROM), a random-access memory (RAM), a cache, or any other storage media in which information is stored for any duration (e.g., for extended time periods, permanently, brief instances, for temporarily buffering, and/or for caching of the information). As used herein, the term non-transitory computer readable medium is expressly defined to include any type of computer readable medium and to exclude propagating signals.

Alternatively, some or all of the example processes of FIGS. 3-5 may be implemented using any combination(s) of application specific integrated circuit(s) (ASIC(s)), programmable logic device(s) (PLD(s)), field programmable logic device(s) (FPLD(s)), discrete logic, hardware, firmware, etc. Also, some or all of the example processes of FIGS. 3-5 may be implemented manually or as any combination(s) of any of the foregoing techniques, for example, any combination of firmware, software, discrete logic and/or hardware. Further, although the example processes of FIGS. 3-5 are described with reference to the flow diagrams of FIGS. 3-5, other methods of implementing the processes of FIGS. 3-5 may be employed. For example, the order of execution of the blocks may be changed, and/or some of the blocks described may be changed, eliminated, sub-divided, or combined. Additionally, any or all of the example processes of FIGS. 3-5 may be performed sequentially and/or in parallel by, for example, separate processing threads, processors, devices, discrete logic, circuits, etc.

FIG. 3 relates to an example method 300 that enables medical providers to post opening(s) in their schedule. The openings may be caused by last-minute cancellations or may be associated with future open appointments, for example. The method 300 enables patients or referring providers to schedule an appointment in the posted opening that may other pass by unutilized, for example. In some examples, the method 300 enables patients having certain criteria met to schedule in the posted opening based on priority.

Referring to FIG. 3, at 302, the method 300 determines if there is an available opening and/or if there is a new available opening. In some examples, a system may interact with a healthcare scheduling system to automatically identify if there are any available openings. In some examples, the system may be notified by a healthcare provider of an available opening. At 304, the method 300 determines if there are any stand-by patients. In some examples, users may register as a stand-by patient via a website associated with a scheduling system. In some examples, users may enter criteria associated with an appointment request via a website associated with a scheduling system. The information entered by the user may be saved at a data store and may be later retrieved.

At 306, the method determines whether or not the stand-by patient's criteria is met by the available opening. For example, a stand-by patient's criteria may be met if the available appointment is a dermatologist appointment on a Tuesday morning within 15 miles of the stand-by patient's residence. At 308, the method determines whether or not one or more of the stand-by patients is associated with an auto-accept feature. In some examples, the stand-by patients may select from between an auto-accept feature or a feature in which the stand-by patient is notified and given the option whether or not they would like to accept the appointment. If one or more of the stand-by patients is associated with the auto-accept feature, control advances to block 310.

At 310, the method 300 sorts the one or more stand-by patients associated with the auto-accept feature based on priority. In some examples, a first stand-by patient having registered first with the scheduling system as auto-accept may be given priority over a second stand-by patient having registered second with the scheduling system as auto-accept. In some examples, the first stand-by patient in greater need of care may be given higher priority than a second stand-by patient in lesser need of care. At 312, the method 300 identifies the stand-by patient having the highest priority level.

At 314, the method 300 may notify the healthcare provider of the patient requesting to be scheduled in the open appointment or the method 300 schedules the patient requesting to be scheduled in the open appointment. In some examples, the scheduling system may interact with a healthcare scheduling system to automatically schedule the patient in the open appointment. In some examples, the scheduling system may provide contact information of the patient to the healthcare scheduling system to facilitate scheduling.

However, if no stand-by patients are associated with the auto-accept feature, control advances to block 316. At 316, the method 300 notifies one or more other stand-by patients of the open appointment. The other stand-by patients may be notified of the open appointment using an access device (e.g., a mobile device, a desktop, etc.). In some examples, the other stand-by patients may be stand-by patients that requested to be notified of open appointments meeting certain criteria. The other stand-by patients may be notified by voice or text messaging (e.g., phone, SMS, e-mail services, etc.).

At 318, the method 300 determines if one of the other stand-by patients has accepted the available opening. The other stand-by patients may accept the available opening using an access device. In some examples, the first of the other stand-by patients to accept the available opening may be the individual to be later scheduled in that appointment. If one of the other stand-by patients has accepted the available opening, control advances to block 314.

If none of the other stand-by patients accept the opening, at 320, the open appointment may be published to the public or others may be notified of the open appointment. In some examples, the open appointment may be published by posting the open appointment on a forum or website. In some examples, the open appointment may be published using blogging, microblogging or social networking service(s).

At 322, the method 300 may wait for acceptance or for expiration. In some examples, the method 300 may wait for users becoming notified of the open appointment via a website to respond and request the appointment. The appointment may expire if the time at which the appointment is to occur has past.

At 324, the method 300 determines whether or not the open appointment has been accepted. If the open appointment has been accepted, control advances to block 314. Once the provider is notified or the patient is scheduled in the available opening at 314, at 326, the method 300 notifies the patient of the scheduling confirmation. In some examples, the patient may be notified via voice or text messaging (e.g., phone, SMS, e-mail services, etc.). At 328, the method 300 closes the available opening. At 330, the method 300 determines whether or not to determine if there is another available opening. Otherwise the example method 300 is ended.

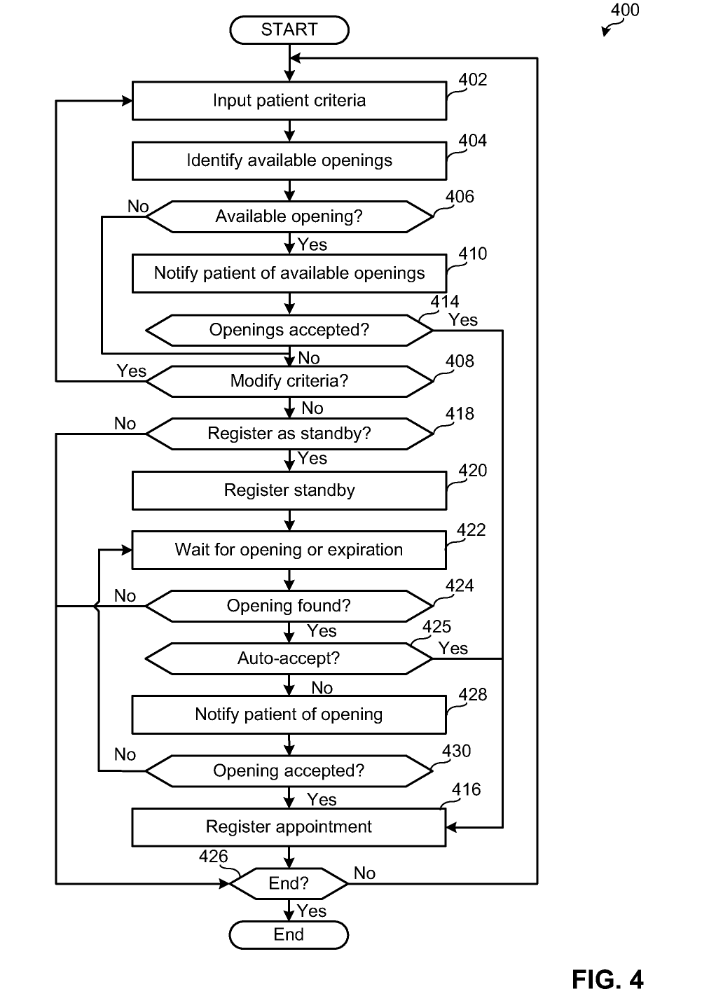

Turning to FIG. 4, at 402 of an example method 400, a user (e.g., patient, referring provider, etc.) inputs criteria into a system. At 404, available opening(s) are identified. In some examples, the available opening(s) may be identified by corresponding with providers and receiving a verification of an available opening meeting the user's criteria. At 406, the method 400 determines if there are any available openings. If there are no available openings, control advances to 408 and the patient may modify the criteria. For example, the patient may modify criteria from only being available on Mondays to being available on both Mondays and Tuesdays.

If there are available openings, control advances to block 410 and the patient is notified of the available openings. At 414, the method 400 determines if the patient accepts the opening(s). If the patient accepts the opening, control advances to 416 and the patient is registered in the appointment. In some examples, the scheduling system interacts with a healthcare scheduling system to automatically schedule the patient in the open appointment once accepted. In some examples, the scheduling system notifies the healthcare provider that the patient accepted the appointment and/or provides the healthcare provider with contact information of the patient to facilitate scheduling.

If none of the openings are accepted, control advances to block 408 where the patient can choose to modify the criteria. If the patient chooses not to modify the criteria, control advances to block 418 where the patient can register as a stand-by. In some examples, the patient can register as a stand-by that auto-accepts appointments meeting the criteria. In some examples, the patient can register as a stand-by patient that is notified of an appointment meeting the criteria but does not automatically accept the open appointment.

If the patient chooses to register as a stand-by, control advances to 420 where the patient is registered as a stand-by. In some examples, the patient's status as a stand-by may be saved in a data store. At 422, the method 400 may wait for an opening or for expiration of the request and at 424 the method 400 may determine if an opening is found. If an opening is not found, control advances to 426.

However, if an opening is found, control advances to 425 where the method 400 determines whether or not the patient has elected to auto-accept. If the patient has elected to auto-accept, control advances to block 416 and the patient is registered in the appointment. If the patient has not elected to auto-accept, control advances to 428 and the patient is notified of the opening. At 430, the method 400 determines if the patient has accepted the opening. In some examples, the patient may accept the opening by responding to a message from a scheduling system. If the patient accepts the opening, control advances to 432 and the patient is registered in the appointment. At 426, the method 400 determines whether or not to advance to block 402. Otherwise the example method 400 is ended.

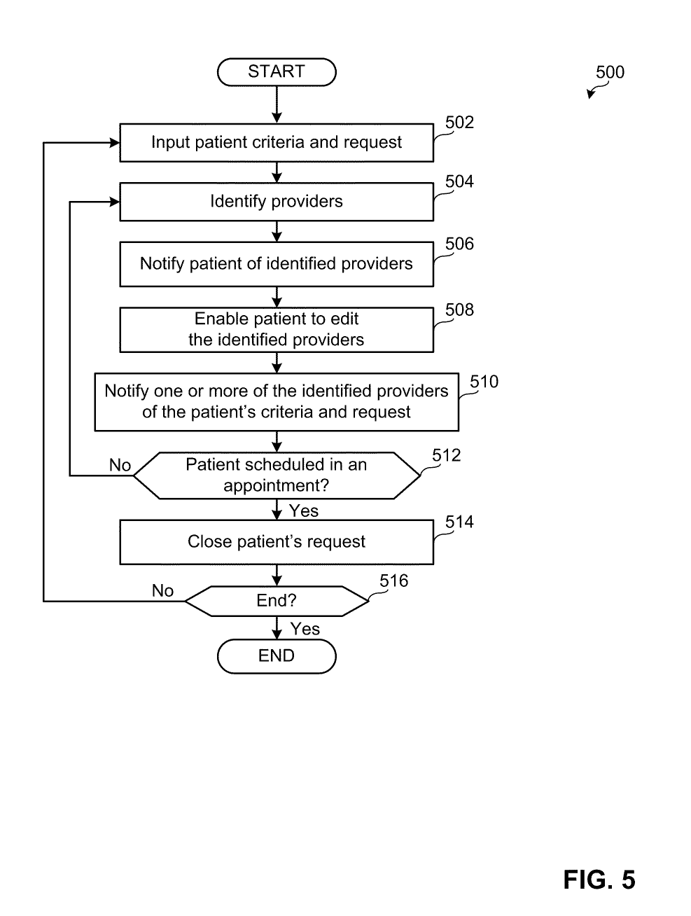

FIG. 5 relates to an example method 500 that may query providers for new available openings, for example. In some examples, the method 500 may query providers to identify new available openings if no posted openings are initially identified that meet the patient's specific criteria.

Turning to FIG. 5, at 502 of the method 500, a user inputs patient criteria and a request. In some examples, the user may input their availability, location, distance, procedure performed, health insurance plan, type of care, symptom exhibited, etc. into a scheduling system. At 504, providers are identified. In some examples, a scheduling system automatically identifies providers that meet the patient criteria and request. At 506, the patient is notified of the identified providers and at 508 the patient may edit the identified providers. In some examples, the patient may edit the identified providers by changing the order in which the providers are contacted. In some examples, the patient may edit the identified providers by removing a particular provider from the list.

At 510, the method 500 notifies one or more of the identified providers of the patient's criteria and request. In some examples, the method 500 automatically identifies providers having available openings meeting the patient's criteria and request. In such examples, the method 500 may schedule the patient in the available opening by interacting with the providers scheduling system. In some examples, a scheduling system may at least initially notify just the first five to ten identified providers. At 512, the method 500 determines whether or not the patient has been scheduled in an appointment. If the patient has been scheduled in an appointment, control advances to 514 and the patient request may be closed. At 516, the method 500 determines whether or not to advance to block 502. Otherwise the example method 500 is ended.

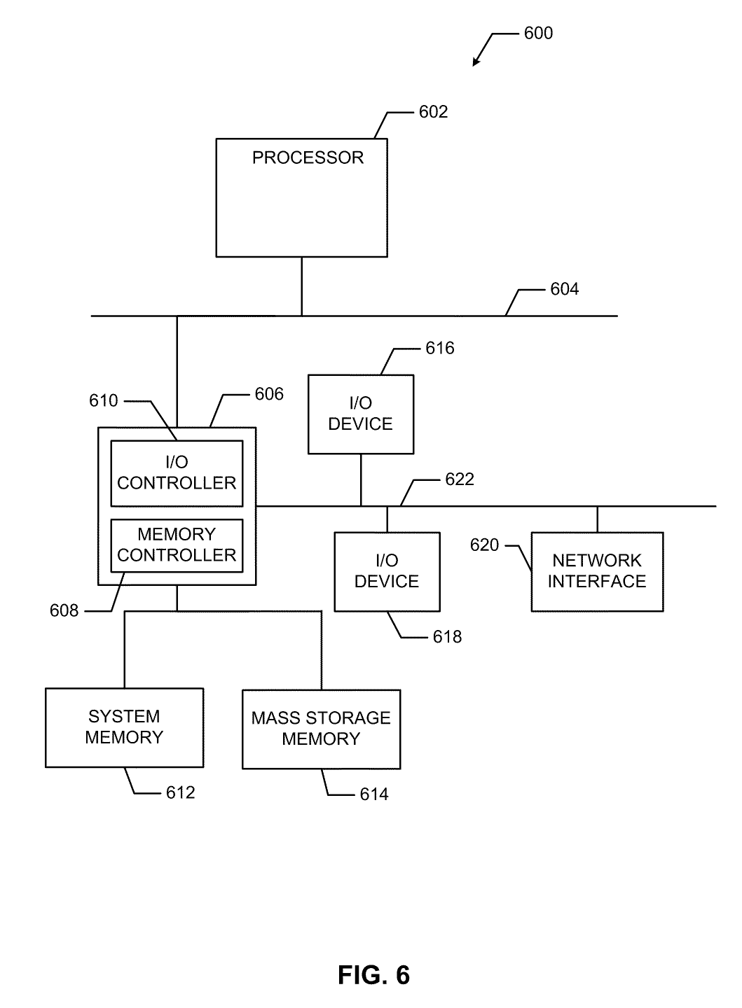

FIG. 6 is a block diagram of an example processor system 600 that may be used to implement the systems and methods described herein. As shown in FIG. 6, the processor system 600 includes a processor 602 that is coupled to an interconnection bus 604. The processor 602 may be any suitable processor, processing unit or microprocessor. Although not shown in FIG. 6, the processor system 600 may be a multi-processor system and, thus, may include one or more additional processors that are identical or similar to the processor 602 and that are communicatively coupled to the interconnection bus 604.

The processor 602 of FIG. 6 is coupled to a chipset 606, which includes a memory controller 608 and an input/output (I/O) controller 610. As is well known, a chipset typically provides I/O and memory management functions as well as a plurality of general purpose and/or special purpose registers, timers, etc. that are accessible or used by one or more processors coupled to the chipset 606. The memory controller 608 performs functions that enable the processor 602 (or processors if there are multiple processors) to access a system memory 612 and a mass storage memory 614.

The system memory 612 may include any desired type of volatile and/or non-volatile memory such as, for example, static random access memory (SRAM), dynamic random access memory (DRAM), flash memory, read-only memory (ROM), etc. The mass storage memory 614 may include any desired type of mass storage device including hard disk drives, optical drives, tape storage devices, etc.

The I/O controller 610 performs functions that enable the processor 602 to communicate with peripheral input/output (I/O) devices 616 and 618 and a network interface 620 via an I/O bus 622. The I/O devices 616 and 618 may be any desired type of I/O device such as, for example, a keyboard, a video display or monitor, a mouse, etc. The network interface 620 may be, for example, an Ethernet device, an asynchronous transfer mode (ATM) device, an 802.11 device, a DSL modem, a cable modem, a cellular modem, etc. that enables the processor system 600 to communicate with another processor system.

While the memory controller 608 and the I/O controller 610 are depicted in FIG. 6 as separate blocks within the chipset 606, the functions performed by these blocks may be integrated within a single semiconductor circuit or may be implemented using two or more separate integrated circuits.

Certain embodiments contemplate methods, systems and computer program products on any machine-readable media to implement functionality described above. Certain embodiments may be implemented using an existing computer processor, or by a special purpose computer processor incorporated for this or another purpose or by a hardwired and/or firmware system, for example.

Certain embodiments include computer-readable media for carrying or having computer-executable instructions or data structures stored thereon. Such computer-readable media may be any available media that may be accessed by a general purpose or special purpose computer or other machine with a processor. By way of example, such computer-readable media may comprise RAM, ROM, PROM, EPROM, EEPROM, Flash, CD-ROM or other optical disk storage, magnetic disk storage or other magnetic storage devices, or any other medium which can be used to carry or store desired program code in the form of computer-executable instructions or data structures and which can be accessed by a general purpose or special purpose computer or other machine with a processor. Combinations of the above are also included within the scope of computer-readable media. Computer-executable instructions comprise, for example, instructions and data which cause a general purpose computer, special purpose computer, or special purpose processing machines to perform a certain function or group of functions.

Generally, computer-executable instructions include routines, programs, objects, components, data structures, etc., that perform particular tasks or implement particular abstract data types. Computer-executable instructions, associated data structures, and program modules represent examples of program code for executing steps of certain methods and systems disclosed herein. The particular sequence of such executable instructions or associated data structures represent examples of corresponding acts for implementing the functions described in such steps.

Embodiments of the present invention may be practiced in a networked environment using logical connections to one or more remote computers having processors. Logical connections may include a local area network (LAN) and a wide area network (WAN) that are presented here by way of example and not limitation. Such networking environments are commonplace in office-wide or enterprise-wide computer networks, intranets and the Internet and may use a wide variety of different communication protocols. Those skilled in the art will appreciate that such network computing environments will typically encompass many types of computer system configurations, including personal computers, hand-held devices, multi-processor systems, microprocessor-based or programmable consumer electronics, network PCs, minicomputers, mainframe computers, and the like. Embodiments of the invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

Although certain methods, apparatus, and articles of manufacture have been described herein, the scope of coverage of this patent is not limited thereto. To the contrary, this patent covers all methods, apparatus, and articles of manufacture fairly falling within the scope of the appended claims either literally or under the doctrine of equivalents.

What is claimed is:

1. A computer implemented method of facilitating the scheduling of appointments in healthcare environments, comprising:
identifying an available opening associated with a provider, wherein the provider is to communicate with a scheduling system regarding the available opening;
identifying one or more stand-by patients seeking an appointment, wherein the one or more stand-by patients are to communicate with the scheduling system regarding an appointment sought including criteria based on at least one of a type of care or a symptom exhibited;
determining whether the criteria of the one or more stand-by patients is met by the available opening using a processor;
notifying the provider of one of the one or more stand-by patients having their criteria met by the available opening;
facilitating scheduling of the one of the one or more stand-by patients in the available opening; and
notifying the one of the one or more stand-by patients of a scheduling confirmation associated with the available opening.

2. The method of claim 1, wherein facilitating the scheduling of the one of the one or more stand-by patients in the available opening comprises automatically scheduling the one of the one or more stand-by patients in the available opening.

3. The method of claim 1, wherein identifying the available opening comprises automatically identifying the available opening on a healthcare scheduling system.

4. The method of claim 1, further comprising determining whether the one or more stand-by patients having their criteria met is associated with an auto-accept feature.

5. The method of claim 4, further comprising sorting the one or more stand-by patients having their criteria met and associated with the auto-accept feature based on a priority level.

6. The method of claim 5, wherein notifying the provider of the one of the one or more stand-by patients having their criteria met comprises notifying the provider of the stand-by patient having their criteria met, associated with the auto-accept feature, and having the highest priority level.

7. The method of claim 5, further comprising notifying one or more other stand-by patients of the available opening if none of the one or more stand-by patients is associated with the auto-accept feature.

8. The method of claim 7, wherein notifying the provider of the one of the one or more stand-by patients having their criteria met comprises notifying the provider of one of the one or more other stand-by patients that accepted the available opening.

9. The method of claim 1, further comprising notifying others of the available opening if none of the criteria of the one or more stand-by patients is met by the available opening.

10. The method of claim 9, wherein notifying others comprises publishing the available opening to the public via at least one of a website, a forum, blogging, microblogging, or a social networking service.

11. The method of claim 9, further comprising notifying the provider of one of the others that accepted the available opening.

12. The method of claim 11, wherein notifying the provider of the one of the others that accepted the available opening comprises scheduling the one of the others in the available opening.

13. The method of claim 12, further comprising notifying the one of the others of a scheduling confirmation associated with the available opening.

14. The method of claim 1, wherein notifying the provider of the one of the one or more stand-by patients having their criteria met by the available opening comprises scheduling the one of the one or more stand-by patients in the available opening.

15. The method of claim 14, further comprising closing the available opening once a patient is scheduled for the available opening.

16. A computer implemented method of facilitating the scheduling of appointments in healthcare environments, comprising:
enabling a stand-by patient to communicate with a scheduling system regarding an appointment sought including criteria based on at least one of a type of care or a symptom exhibited;
identifying one or more providers based on the criteria;
determining if the one or more providers has an available opening that meets the criteria of the stand-by patient, wherein the one or more providers are to communicate with the scheduling system regarding the available opening that meets the criteria of the stand-by patient;
notifying the stand-by patient of one or more available openings that meet the criteria of the stand-by patient; and
facilitating scheduling of the stand-by patient in one of the one or more available openings.

17. The method of claim 16, wherein facilitating scheduling of the stand-by patient in one of the one or more available openings comprises automatically scheduling the stand-by patient in one of the one or more available openings.

18. The method of claim 16, further comprising enabling the stand-by patient to edit the one or more identified providers.

19. A medical scheduling system, comprising:
a data storage to store data including information associated with an open appointment and information associated with at least one of a type of care or a symptom exhibited by a patient; and
a processor to receive input from a first access device associated with the open appointment; the processor to identify a patient appointment request based on at least one of a type of care or a symptom exhibited by the patient from input received from a second access device; the processor to convey input received from the first access device to the second access device to facilitate scheduling the patient in the open appointment.

20. The medical conferencing system of claim 19, wherein the first access device is associated with a healthcare facility and the second access device comprises a mobile device.
